(19) United States
(12) Patent Application Publication
(10) Pub. No.: US 2012/0218127 A1
(43) Pub. Date: Aug. 30, 2012

(54) Terminal Intelligent Monitoring System

(76) Inventor: Christopher Finley Kroen, Nanuet, NY (US)

(21) Appl. No.: 13/468,443

(22) Filed: May 10, 2012

(51) Int. Cl. G08B 21/00

(52) U.S. Cl. 340/945

(57) ABSTRACT

A flight information system, accessories, methods of use and applications are disclosed herein. A central computer system programmed to retrieve and analyze flight relevant data, including weather, operational, ground condition, aircraft condition, and navigational status data, is provided. Additionally, user terminals in communication with the central computer system may optionally send and receive data as well as program the central computer. Pre-programmed and user configurable alerts are provided. To minimize pilot decision process errors, a “Go” or “No Go” determination may be made by the system. Interaction with a human or computerized analysis based advisor is optionally available through the system upon request of the user.

### TECHNICAL FIELD

This invention relates to an apparatus for monitoring, analyzing, and reporting flight, weather, aircraft and ground condition status, as well as systems and methods of using the same.

### BACKGROUND

Presently, all flights conducted globally must first comply with CFR 14 91.103 or its international ICAO state equivalent. Put simply, a pilot must preplan a flight by becoming familiar with all aspects of that flight. A pilot must make a determination as to the safety of each flight by manually acquiring and interpreting dozens of specific passive text products that include weather, operational and navigational reports, all of which are time sensitive. The end result is a labor intensive and often incomplete or outdated assessment that does not comply with the above requirement. Current aviation stakeholders (pilots, dispatchers, aviation industry management, business travelers, etc) lack an active global airport monitoring program the compares airport specific geographical and navigational parameters with current and predicted weather. The end result is that stakeholder must manually check multiple weather, airport, and other relevant data streams, compare each with specific airport and aircraft data to determine if safe, legal or efficient flight operations can or will occur. The FAA and NTSB regularly state in accident reports that had previously publically available data been interpreted and correlated correctly, the accident could have been prevented by pilots not having placed their aircraft in an unsafe terminal airport environment, demonstrating a long felt need for a better system. One aspect of particular concern is that the available data products (weather and airport environment conditions) are issued at different times or when conditions warrant. Since all presently available preflight briefing systems rely on the user to obtain these reports, timely data collection and correlation to other previously published data can be impractical.

Globally, the current methods of obtaining and disseminating weather data for airports rely purely on the end user manually to read and compare that data with specific airport and aircrafts requirements for safe, legal, and efficient operation. There is no system that employs real time intelligent monitoring and comparing of airport weather to the limitations of the airports and/or the aircraft intended for flight operation. In short, weather data, airport data, aircraft data and legal limitations are published separately. There is no known system for actively and continuously monitoring conditions for specific users preferences then issuing alerts with a condition exists or is predicted to exist that would cause unsafe, illegal or inefficient flight operations. There is also no system that will recommend alternate courses of action during the preflight planning phase.

### SUMMARY

The Terminal Intelligent Monitoring System (hereinafter “TIMS”) is a computer-based system that will collect and store any data that may be relevant to a flight (hereinafter “TIMS Data”). In certain embodiments, TIMS Data may be processed, filtered, or analyzed according to a variety of algorithms. TIMS then may optionally deliver TIMS Data to end-users in a variety of formats and through a variety of access or delivery methods. End-users may query TIMS to receive query responses, including query responses relating to or consisting of TIMS Data. End-users may program TIMS via a variety of interfaces and methods to schedule routine or one time communications of TIMS Data as well as programmed alerts in certain circumstances. These communications and alerts may be delivered to the end-users in a variety of formats and via a variety of delivery mechanisms.

### BRIEF DESCRIPTION OF THE FIGURES

The foregoing and other objects, features and advantages of the invention will be apparent from the following description of embodiments, including the preferred embodiment, as illustrated in the accompanying drawings in which reference designations refer to the same parts throughout the various views. The drawings are not necessarily to scale, emphasis instead being placed upon illustrating the principles of the invention. It will be appreciated by one of ordinary skill in the art that these exemplary figures do not limit the invention, but rather depict various embodiments of the invention.

FIG. 1 depicts a functional block diagram of an exemplary TIMS system according to one embodiment of the present invention, wherein several devices communicate via networks to practice aspects of the invention.

FIG. 2 depicts a functional block diagram of an exemplary TIMS system according to one embodiment of the present invention, wherein one server-type device practices aspects of the invention.

FIG. 3 depicts a functional block diagram of an exemplary TIMS system according to one embodiment of the present invention, wherein one terminal-type device practices aspects of the invention.

FIG. 4 depicts an exemplary process, in flow-chart form, for practicing one aspect of the invention by performing an exemplary flight check procedure on a TIMS systems, including the exemplary TIMS systems of FIGS. 1-3. It must be appreciated that practicing the invention does not require undertaking each of the steps depicted or undertaking said steps in the order depicted, in other words the invention can be practiced by executing a plurality of the steps depicted in any order.

FIG. 5 depicts exemplary user interface screens for logging into the TIMS system.

FIG. 6 depicts exemplary user interface screens showing diagnostic information for the computer hardware executing the TIMS system.

FIG. 7 depicts exemplary user interface screens showing a subset of the capabilities related to users and alerts for the TIMS system.

FIG. 8 depicts exemplary user interface screens showing the history and status of the retrieval and storage of METAR data.

FIG. 9 depicts exemplary user interface screens showing storage records for airports, including ICAO data; as well as the status of various TIMS data retrieval and storage modules being accessed via a mobile TIMS terminal.

FIG. 10 depicts exemplary user interface screens showing favorite airports attached to a user profile, and the input and editing of favorite airports on a mobile TIMS terminal.

FIG. 11 depicts exemplary user interface screens from a mobile TIMS terminal displaying the capability to acquire, store and retrieve METAR data.

### DETAILED DESCRIPTION

As described below, the apparatuses, systems and methods of the invention employ one or more computing devices to collect, store, process, generate and deliver data relevant to the TIMS system (hereafter “TIMS data”), and also to present information and an interface to the TIMS to end users.

Throughout this description examples may be presented. These examples are intended only to illustrate the principles of the invention and do not limit it. In the interest of eliminating unnecessary repetition and elevating substance over form in this written description of the invention, where examples are provided the example will not be repeated for each of the items in a list or category because it will be apparent to a person of ordinary skill in the art that the description of the set, list or category provided, in combination with the illustrative example, describes in sufficient detail, distinctly points out, and enables said person of ordinary skill in the art to practice the invention disclosed herein by generalizing any provided illustrative example across the set of similar items to which the example applies. Indeed, even where no example is provided, such a person of ordinary skill in the art will be able to read this written description and know how to predictably practice any of the multiple aspects or embodiments of this invention. Likewise, the examples presented herein expand on, and are expanded upon, by the descriptions elsewhere in this disclosure and description of the invention.

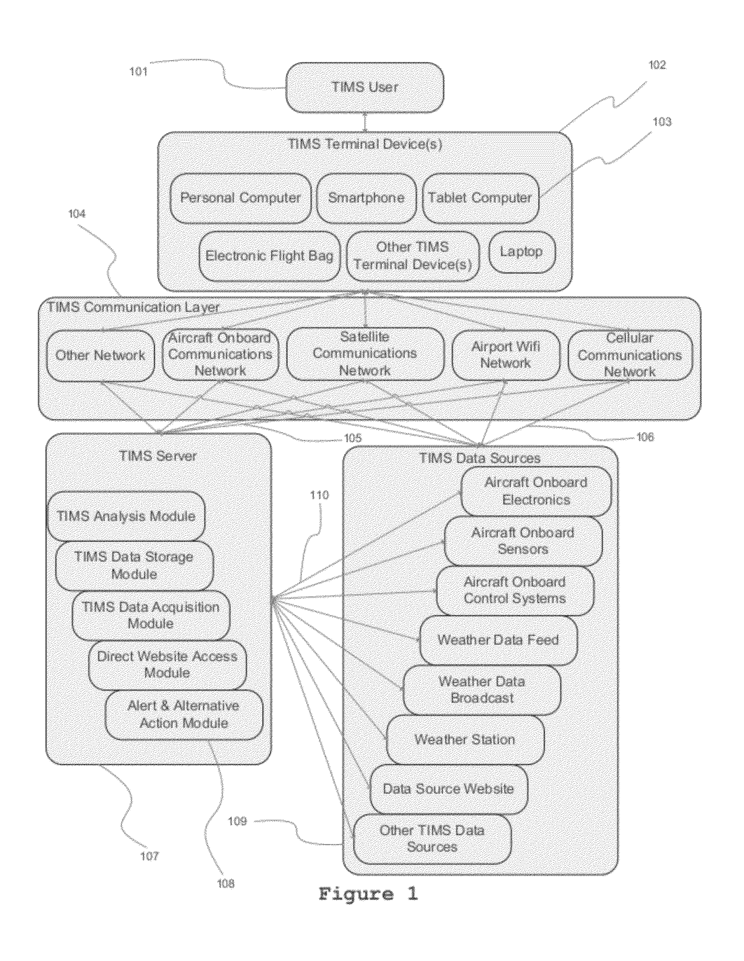

An exemplary aspect of the invention is shown and displayed in FIG. 1. A TIMS User 101, who could be a pilot, ground crew, flight crew or flight attendant, passenger, or any other aviation stakeholder uses a TIMS Terminal Device or Devices 102 to interact with the system and obtain flight information. For example, the TIMS User 101 might use a Tablet Computer 103, a laptop, a smart-phone, an electronic flight bag, a personal computer, or any other device capable of interacting with or executing TIMS systems. The TIMS Terminal Device may interface with other TIMS devices, for example a TIMS Server 107, through a TIMS Communication Layer 104, to enable communication 105 between the TIMS Terminal Device and the TIMS Server, for the ultimate goal of providing the information and analysis to the TIMS User 101. Alternately, the TIMS Terminal Device may interface directly with TIMS Data Sources 109 using a TIMS Communication Layer 104 to enable communication 106 between the TIMS Terminal and the TIMS Data Sources. The TIMS Communication Layer may be one, or a combination of, a cellular communications network, an airport Wi-Fi network, a satellite communications network, an aircraft onboard communications network, or some other digital communications network. Running on the TIMS Server are TIMS Modules, including for example the Alert & Alternative Action Module 108, the Direct Website Access Module, the TIMS Data Acquisition Module, the TIMS Data Storage Module, and the TIMS Analysis Module. These modules may communicate with TIMS Data Sources directly via a direct link between the TIMS Server and the TIMS Data Sources 110 or via the TIMS Communication layer.

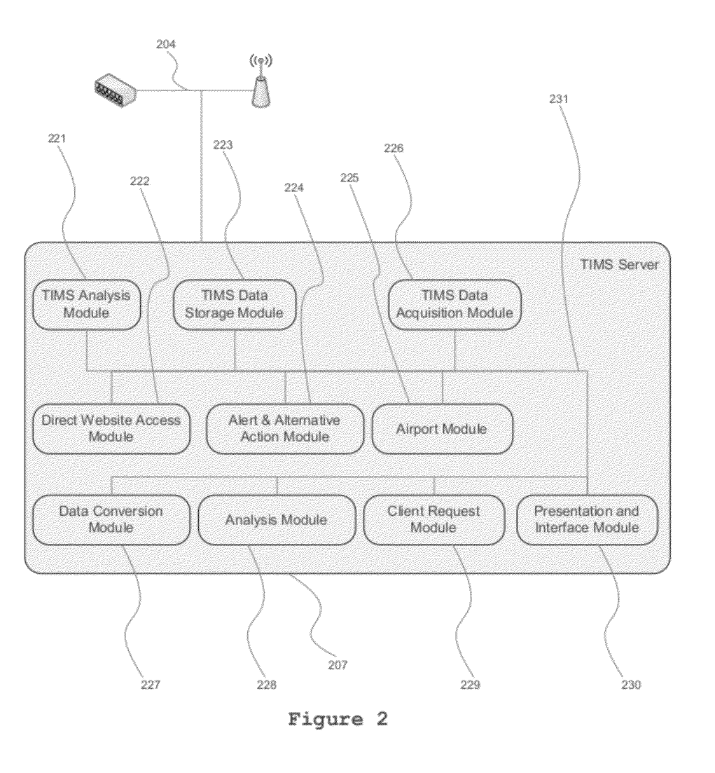

Another exemplary aspect of the invention is shown and displayed in FIG. 2. A TIMS Server 207 may contain a plurality of TIMS Modules. Each of the modules may communicate with a plurality of the other modules via any number of techniques known to those of skill in the art, for example message passing 231 or object oriented programming techniques. A TIMS Server may also optionally be implemented as several physical or virtual servers each of which executes a plurality of TIMS Modules, in which case the physical or virtual servers may be connected via wired or wireless network connections 204. A TIMS Server may communicate with other TIMS Servers, TIMS Data Sources or TIMS Terminal Devices via its wired or wireless network interface 204. Among other modules and features, the TIMS Server may optionally execute a plurality of TIMS Modules including: a TIMS Analysis Module 221 which may, for example, perform neural network based, expert system based, heuristic based, or simple comparison and contrasting analyses of TIMS Data; a TIMS Data Storage Module 223, which may for example store received and/or acquired data, including TIMS Data, into a database or filesystem or other data filing system; a TIMS Data Acquisition Module 226 which may, for example, download or receive TIMS Data related to weather, flight conditions, airport conditions, and other TIMS Data; a Direct Website Access Module 222 which may, for example, permit access of the TIMS System via a web browser; an Alert & Alternative Action Module 224 which may, for example, generate alerts and suggest alternative actions and flight plans; an Airport Module 225 which may, for example, retrieve, store, acquire, and/or provide information on airports; a Presentation and Interface Module 230, which may for example present the data generated by other modules to a TIMS User in a human readable or otherwise attractive format if it is not so generated by the TIMS Module from whence it came; a Client Request Module 229 which may for example receive and process TIMS User requests; an Analysis Module 228 which in combination with the other Analysis module 221 is illustrative of the principle that a TIMS Server may have a plurality of the same type of TIMS Module, for example a neural network based Analysis Module and a heuristic Analysis Module; and/or a Data Conversion Module 227 which may, for example, convert data output by one module into a format usable by another module, or convert received TIMS Data into a common format for storage.

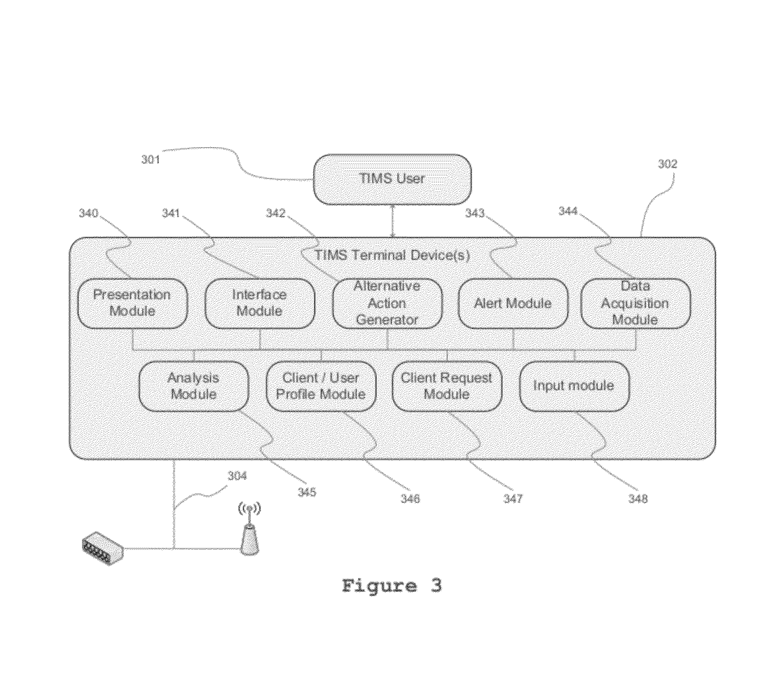

Another exemplary aspect of the invention is shown and displayed in FIG. 3. A TIMS User 301 may use a TIMS Terminal Device or Devices 302 to receive information and/or interact with the TIMS System. The TIMS Device may communicate with other TIMS Devices, with TIMS Data Sources, with aircraft and/or airport instrumentation, or with any other device using wired or wireless network capabilities 304. The TIMS Terminal Device may execute a plurality of TIMS Modules, including: a TIMS Presentation Module 340 for presenting the data generated by other modules to a TIMS User in a human readable or otherwise attractive format if it is not so generated by the TIMS Module from whence it came; a TIMS Interface Module 341 for generating and responding to commands from a TIMS User Interface; a TIMS Alternative Action Generator 342 for generating suggested alternative actions in response to detected unsafe or illegal conditions; a TIMS Alert Module 343 for generating and processing alerts of conditions for users; a TIMS Data Acquisition Module 344 for acquiring TIMS Data from various data sources including FAA and NOAA feeds and other weather information, as well as aircraft instrumentation; a TIMS Analysis Module 345 for performing analyses of TIMS Data; a TIMS Client/User Profile Module 346 for storing, retrieving, and using client and/or user profiles to modify the display or operation of the TIMS Device; a TIMS Client Request Module 347 for receiving, processing, storing and acting upon requests from users to, for example, define particular types of alerts or analyses as well as to configure the look and feel of the TIMS Device; and a TIMS Input Module 348 for receiving and processing TIMS User input.

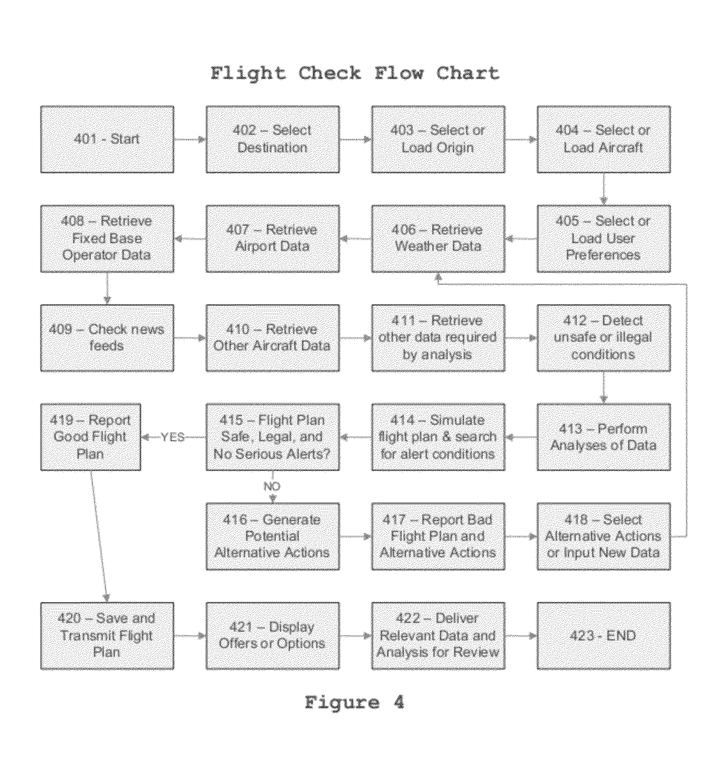

Another exemplary aspect of the invention is shown and displayed in FIG. 4, which depicts a flow-chart representation of an embodiment for conducting a TIMS Flight Check operation. It will be appreciated that this collection and sequence of steps is purely exemplary, the invention could be practiced with any plurality of these steps and in any order Beginning from Start 401, a destination is selected 402, an origin is loaded or selected 403, an aircraft or aircraft type is selected or loaded 404, user preferences are selected or loaded 405, weather data is retrieved 406, airport data is retrieved 407, fixed base operator data is retrieved 408, news feeds (such as Google News, RSS feeds, CIA world factbook, or other news sources) are retrieved 409, aircraft data is retrieved 410, and other data required by or useful to the analysis is retrieved 411. It shall be understood that the origin information can be input by the user, or the invention may identify the origin based on the current location using electronic location techniques well known in the art. Once TIMS Data has been acquired (e.g. steps 401-411), unsafe or illegal conditions are detected 412, including but not limited to by performing analyses of data 413, and/or simulating the flight plan and searching for alert conditions 414. Having detected alert conditions, the flight check process determines whether the flight plan is safe, legal, and has no serious alerts 415. If the flight plan is unsafe, illegal, and/or has serious alerts, the process continues to generate potential alternative actions 416 and report the faulty flight plan to the user along with alternative flight plans or other actions 417. At this point, the user can select an alternative action, or input new data 418, and the process loops back to begin retrieving TIMS Data for analysis 406. On the other hand, if the flight plan was found to be safe, legal, and have no serious alerts, the good flight plan is reported to the user 418, saved and transmitted to other TIMS Devices 420 possibly including a TIMS Server. At this point, offers, advertisements, or other options could be displayed 421. The process concludes by delivering a report to the user and any other desired recipients on the flight plan for review 422.

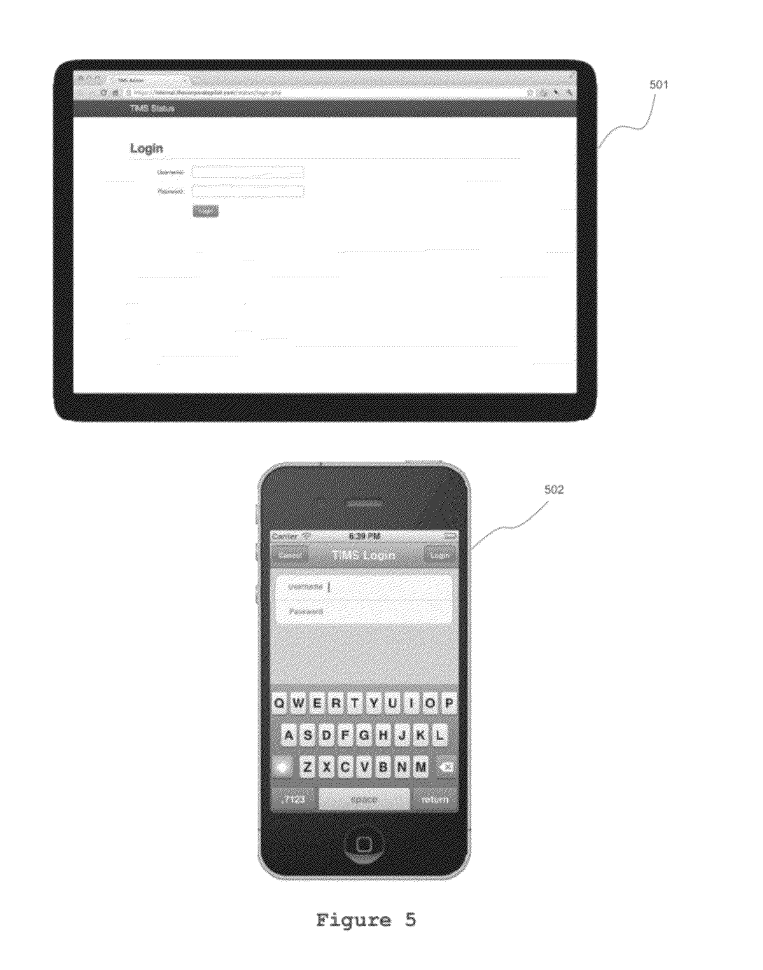

Another exemplary aspect of the invention is shown and displayed in FIG. 5, which depicts sample TIMS User login interfaces on a desktop computer 501 and on a smartphone 502. Note that the user interface may optionally be generated by a TIMS Interface module, but presented to the user in the desktop/browser format by the TIMS Presentation Module and the TIMS Direct Website Access Module, and to the smartphone via the TIMS Presentation Module.

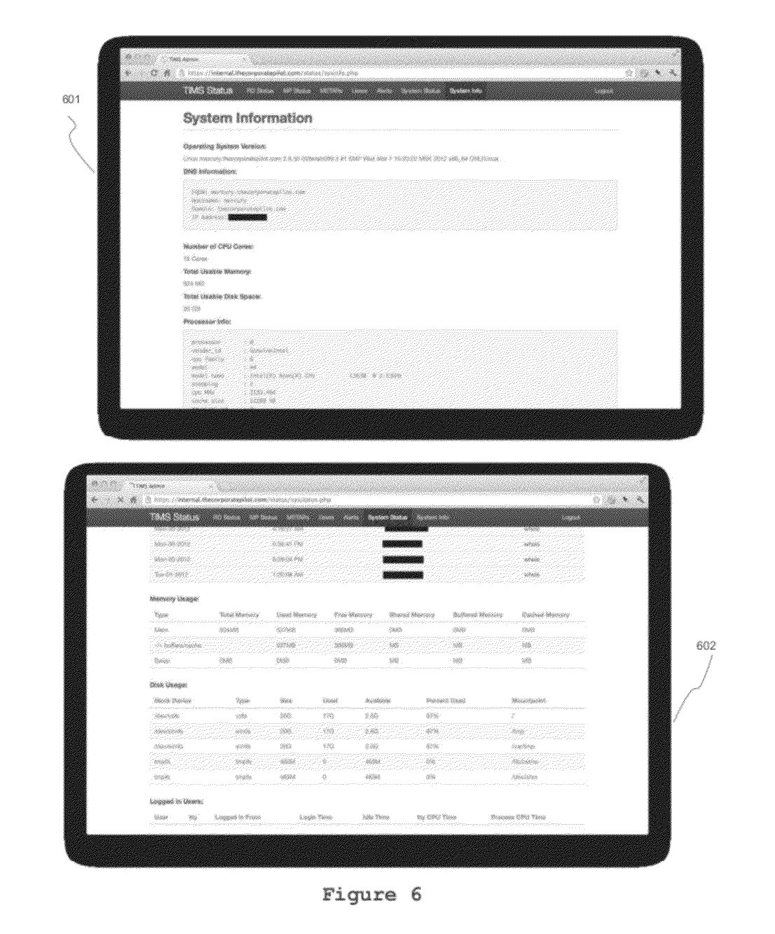

Another exemplary aspect of the invention is shown and displayed in FIG. 6, which depicts the hardware configuration of an exemplary embodiment of the TIMS Server via the TIMS Direct Website Interface Module 601/602.

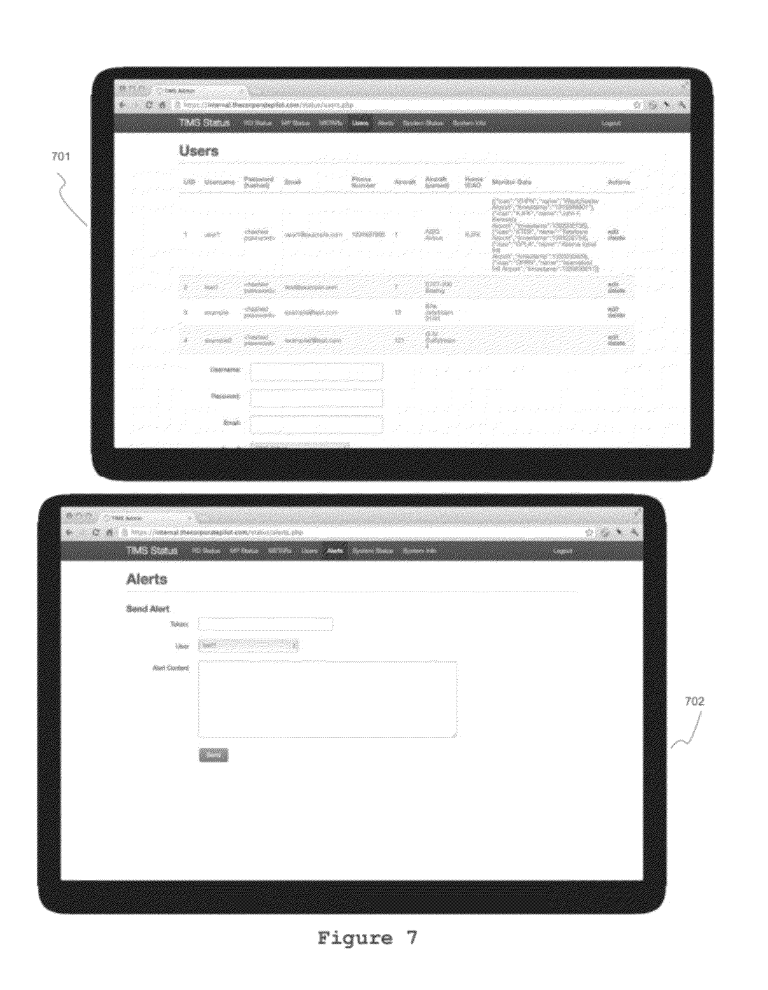

Another exemplary aspect of the invention is shown and displayed in FIG. 7, which depicts additional user interface screens. A user management page is depicted 701 which displays a subset of the information stored by the TIMS User Profile Module. Additionally, an alert sending interface 702 is depicted which allows a user to send a manual alert to another user via their TIMS Terminal Device or via the TIMS Direct Web Access Module.

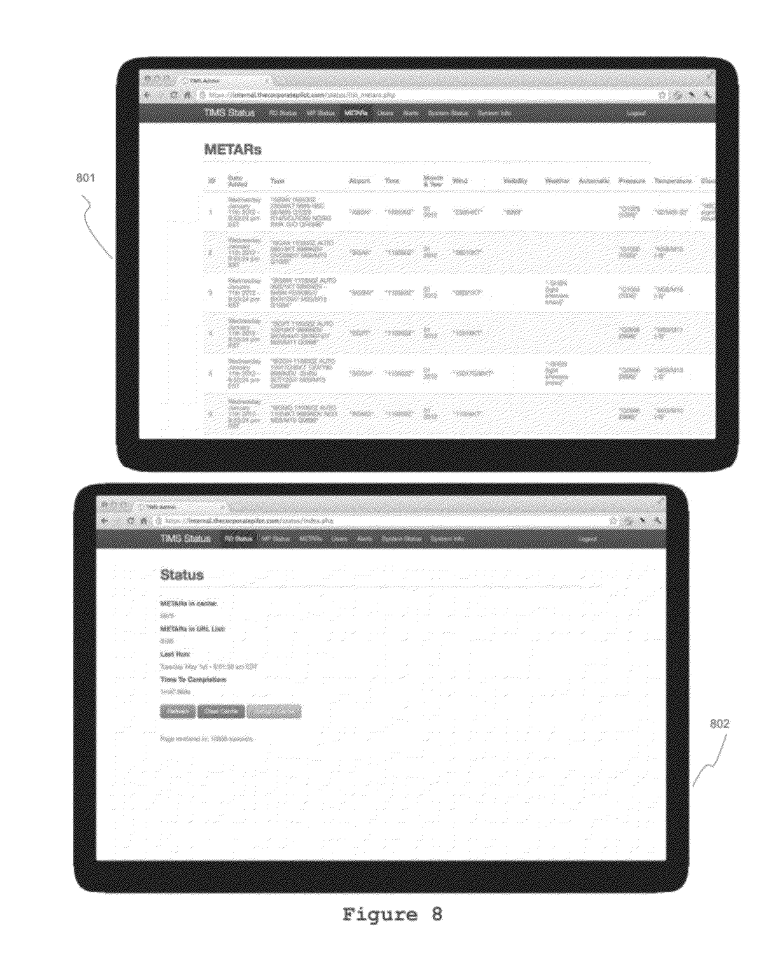

Another exemplary aspect of the invention is shown and displayed in FIG. 8, which depicts a user interface page for the TIMS Acquisition and Storage modules used for acquiring METARs data 801, and the status of METAR data collection 802.

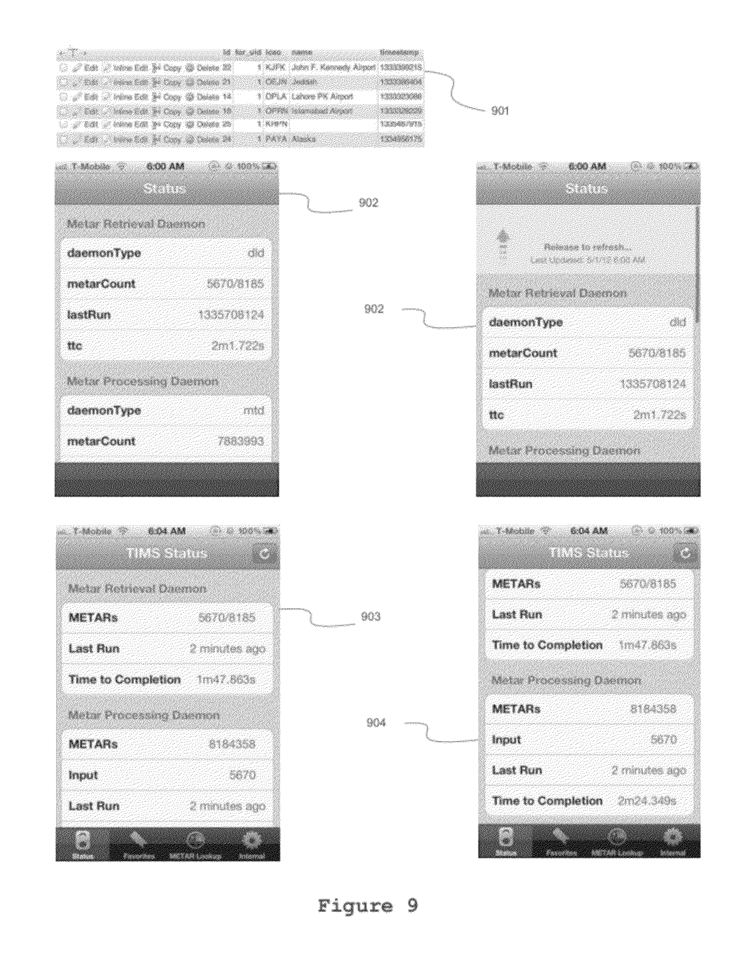

Another exemplary aspect of the invention is shown and displayed in FIG. 9, which shows a variety of administrative interfaces for the TIMS system. A depiction of a TIMS Airport Module is provided 901 showing the airports that this instance of TIMS is collecting data for. A smartphone interface is displayed which shows the status of the METAR retrieval daemon 901, part of the TIMS Data Acquisition module, and also the gesture used to refresh the data on the TIMS Terminal from the TIMS Server 920. A second status screen is provided which shows some of the statistics relevant to the operation of the METAR component of the TIMS Data Acquisition module 903/904.

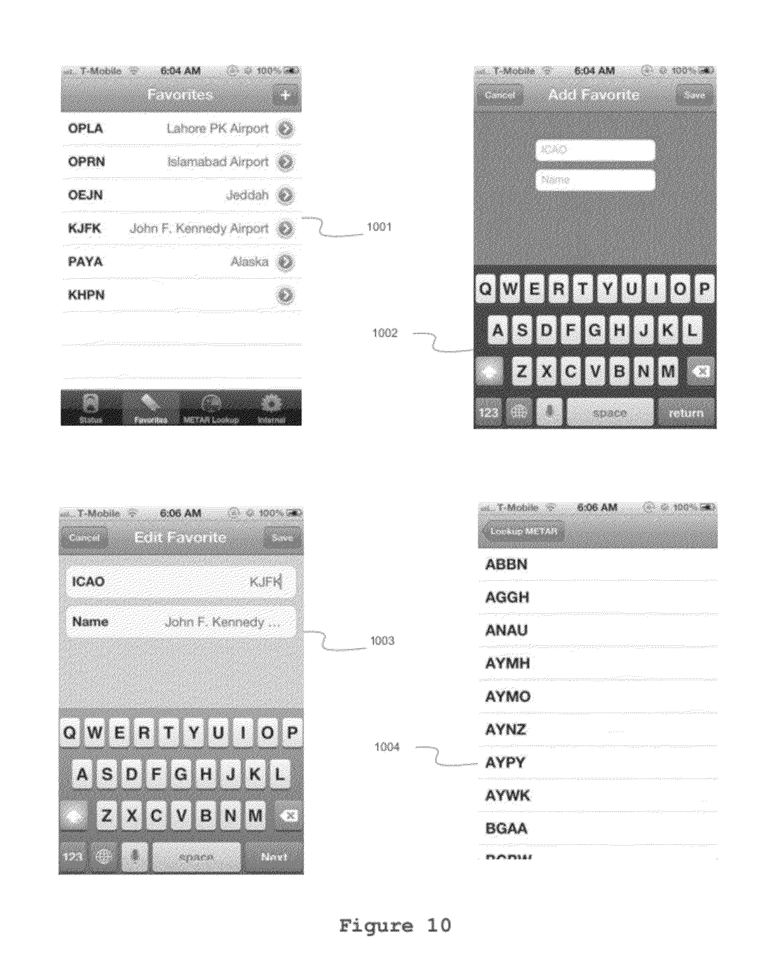

Another exemplary aspect of the invention is shown and displayed in FIG. 10, which depicts user interface screens for viewing 1001 and adding 1002-1004 favorite airports by looking up their corresponding ICAO identifiers.

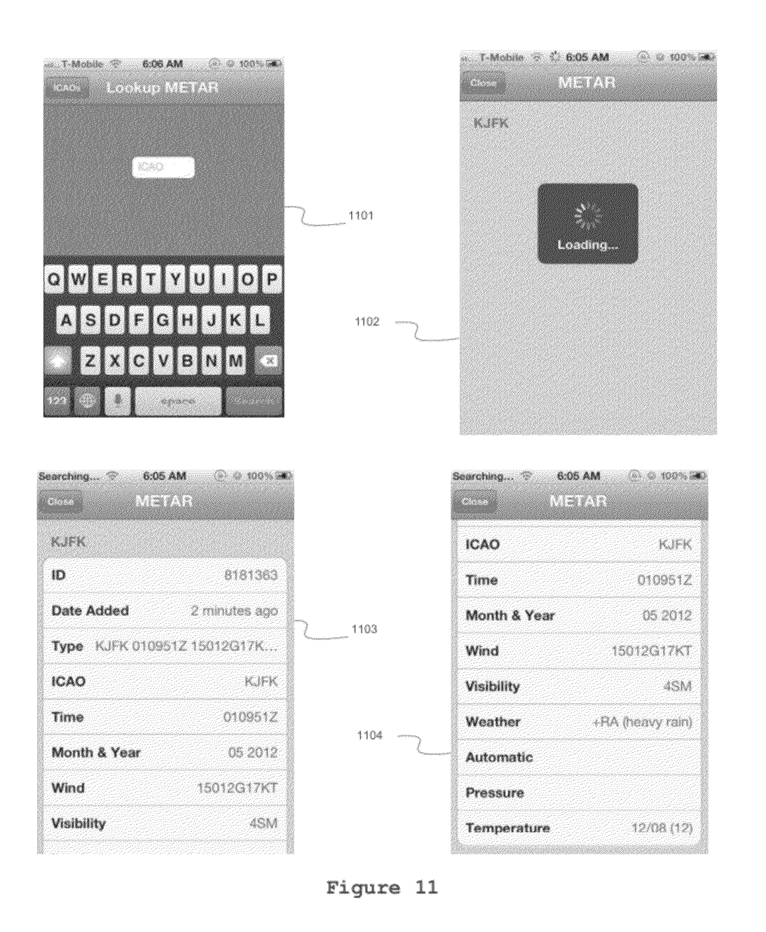

Another exemplary aspect of the invention is shown and displayed in FIG. 11, which depicts smartphone user interface screens for retrieving METAR data directly by a TIMS User. A user can lookup METAR data 1101, the data is retrieved from the data source or from the TIMS Server or TIMS Data Storage Module 1102, and displayed to the TIMS User 1103, 1104.

### Certain Innovative Aspects of the Invention

In certain aspects, and in some embodiments, TIMS may provide one or more of the following innovative functionalities:
An active terminal area weather and airport surface condition monitoring and alerting system.
A complete weather database and artificial intelligence system to parse weather and airport condition data feeds or products to provide comprehensive real time condition and safety of flight alerts to flight crew, passengers, and other stakeholders.
A real time monitoring and alerting system based on of aviation data and computerized text products disseminated by NOAA and the FAA specific to a terminal area.
A real time aviation flight planning aid specifically designed to improve flight crew situational awareness prior to and during operations.
An active interpretation and embodiment of a Safety Management System, responsive in real-time to operational and condition changes.
A real time user-alerting Safety Management System that employs artificial intelligence agents and that is user configurable.
A neural network based weather conditions analyzer used to identify, in real time, actual or predicted unsafe or illegal flight operations in a terminal weather area.
A workflow model, which may use artificially intelligent agents, that provides a practical approach to flight planning for pilots.
A historical database of terminal area weather and surface conditions for all ICAO reporting airports globally.
An automated system to allow US certified pilots to comply with CFR FAR 91.103 and other relevant regulations with respect to preflight planning
A comprehensive and continuous system for monitoring and alerting of an airport environment via mobile device notification.
A one step process to provide intelligent and legally compliant monitoring of a terminal area specific to flight operations.
The generation of automatic and/or configurable alerts of impending or current unsafe terminal area conditions, including the airport surface and ramp, where the terminal area includes preset distances around the airport (e.g. 5 miles, 25 miles, 50 miles, or 100 miles).
Real time preflight and in-flight notification of conditions including: weather below approach minimums, wind exceeding aircraft demonstrated limits, wind shear, surface icing, and contaminated runway conditions.
Predictive alerting of conditions such as: fog, visibility, and clout ceiling below operating limits.
The intelligent sorting and issuance of alerts based on time to actual operation and “need to know” and “just in time” model bases.
A global statistical and historical database of airport conditions.
Landing approach procedure monitoring and alerting of configurable conditions.
A device, service, and/or process which provides combined weather alerts and destination specific services and/or advertisements.
Active alerts from flight operation to the general flying public.

### Hardware Systems

Unless specifically stated otherwise in the following discussion, it is appreciated that throughout the description, discussions utilizing terms such as “processing” or “computing” or “collecting” or “analyzing” or “calculating” or “determining” or “displaying” or “presenting” or “storing” or “software” or “module” or “subroutine” or “program” or the like, can refer to the action, processes of a data processing system, or similar electronic device, that manipulates and transforms data represented as physical (electronic, magnetic, nuclear or quantum) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general-purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), flash memory, magnetic or optical cards, or any type of media suitable for storing electronic instructions, and each coupled to a bus.

Some exemplary embodiments described herein may be described as software executed on at least one computer, though it is understood that embodiments can be configured in other ways and retain functionality. The embodiments can be implemented on known devices such as a server, a personal computer, a special purpose computer, a programmed microprocessor or microcontroller and peripheral integrated circuit element(s), and ASIC or other integrated circuit, a digital signal processor, a hard-wired electronic or logic circuit such as a discrete element circuit, a server, a tablet computer, a wireless handheld device, a cell phone or smartphone, a netbook, an electronic flight bag, or the like. Specific devices which might be used as a computing component of the system include iPad, Android, Kindle or other tablet computers; iPhone, Android or other cellphones or smart-phones; or laptop computers such as those commonly manufactured by Apple, Lenovo, Dell or HP. In general, any device or devices capable of implementing the processes described herein can be used to implement the systems and techniques according to this invention.

It is to be appreciated that the various components of the technology can be located at distant portions of a distributed network and/or the internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. For example, the links or networks might be 802.11 Wi-Fi, Bluetooth, GSM, GPRS, EDGE, 3G, 4G, LTE, satellite network links, fiber optic links, HAM radio, peer-to-peer, mesh network, or any other type of data communications network. It shall be understood that the invention may dynamically update its data and outputs depending on the incoming data and information received from these links or networks. For example, the invention may utilize an aircraft network or Wi-Fi connection to update the TIMS data and use the updated TIMS data to modify or adjust its output parameters including, for example, weather conditions in the flight path or at the arrival location. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

### Configurable Functional Modules

In certain embodiments, the TIMS systems may consist of one or more configurable modules in communication with each other. These modules may be implemented as instructions stored on a processor readable storage medium which are executed by a computing node. As discussed above, these modules may be co-located on a single computing node, or they may be located in physically distinct locations. Each of the modules may be coupled via a data communications network so as to communicate with any or all of the other modules in the system as desired. Generally, unless specifically stated to the contrary in the following discussion, each module is at least in contact with the Data Storage Module. In the discussion of any module, it will be appreciated that any description of a connection or communication between that module and other modules does not limit the invention, in fact each module can be configured to communicate with every or any other module as desired.

As discussed elsewhere, in certain embodiments a plurality of the modules may interface with other modules, including but not limited to other TIMS modules as well as third party modules, and share, request or provide data; generate or respond to queries; store or retrieve data; transmit or receive signals; or do any of the other common tasks or manipulations which computer systems are commonly known to perform with data by those skilled in the art. It will be appreciated that any description of a particular module performing or not performing a specific functionality does not limit the invention, as the functionality of any module could be combined with any other module to form a single module; likewise the functionality of a single module could be divided between two other modules to form two modules. In some embodiments, some modules will share data only with specific other modules, or not at all, or as configured by a user.

It will further be appreciated by one skilled in the art that the written descriptions of the modules, described herein to enable one of ordinary skill in the art to practice this invention, are illustrative only, and elements of the modules may be combined with one another, or separated from one another, to form hybrid modules or sub-modules which are still within the scope of this invention. Likewise it must be appreciated that the descriptions of the data outputs and inputs to the modules are illustrative only and that the invention is not so limited. A module could receive input data from any other module or data source, including any TIMS Data, and could output its data, analyses, or alerts to any other module, to an end-user, or to any other portion of the TIMS System. Similarly, it should be appreciated that a particular analysis technique described in conjunction with a module is not limiting but rather merely illustrative. Any module could employ any analysis technique commonly known in the art, or described herein, to accomplish any of the analyses described here.

### TIMS Data

TIMS Data may include any or all of the following in various embodiments, though of course the invention is not so limited:

a) User profiles, flight plans, aircraft associated with users and/or to flight plans, and aircraft available for selection and use;

b) Terminal, area or global reported and forecasted weather conditions or global weather conditions, temporary or prevailing area weather conditions, weather patterns or other meteorological data;

c) Terminal information for originating, destination and potential intermediary or emergency airports including surface conditions, airport facility conditions, hanger or aircraft parking conditions, ground transportation or connection information, fuel availability and price information and any other available terminal services, conditions, capabilities or disabilities;

d) Airport terminal area, airspace and surrounding territory based threat data, including but not limited data related to the condition of the airport, surrounding area and territory with respect to the safety and efficiency to conduct flight operations, population and political stability, security threats including but not limited to political or military status of relevant territories and territorial airspaces which may be overflown or are adjacent to overflown areas on an actual or potential flight plan, as well as the known or supposed location of ground based stations such as military activity or encampments, radar stations, anti-aircraft emplacements, and surface to air missiles;

e) Aircraft data for some or all aircraft globally, or selectively for relevant or potentially relevant aircraft, where such aircraft may include any aircraft which is or will be physically proximate to an actual or potential course, departure terminal, destination terminal, or alternate airport terminals to a configurable or preset distance (e.g. 10 miles, 50 miles, 100 miles, 1000 miles, or any intermediary distance) from such a terminal area, or those aircraft programmed into the system or selected by a user, or one or more aircraft selected for a flight plan, said aircraft data including: aircraft capabilities, engineering and design information; maintenance and operational status data; position, heading, velocity and other flight and flight plan information; onboard fuel levels, fuel capacity, and fuel economy information; onboard system status including mechanical and other aircraft system status information; current measured airspace conditions, observed or measured meteorological and astronomical conditions, and any other data which may be relevant to or generated by a flight or airplane. For example, although the invention is not so limited, TIMS data could include all available data for each aircraft known to the system globally, as well as various subsets or categories of that global data could be used by embodiments or features of TIMS such as the selection of all aircraft currently in flight or scheduled for flight at a particular time or time window, or aircraft of a certain type, or all aircraft departing from or in transit to a particular airport or region, or aircraft from a certain carrier. In short, any component of the information stored about an aircraft could be used to categorize and select particular groups of aircraft.

f) Data sets or data streams provided by or gathered from third parties, for example NOAA METARS (also known as National Oceanic and Atmospheric Administration Aviation Routine Weather Reports), NOAA METARS backup data sources such as the University of Wyoming, other 3rd Party backup mirrors of NOAA data, NOAA TAFS (also known as Terminal Aerodrome Forecast), FAA ATC (also known as Federal Aviation Administration Air Traffic Control) delays data feeds, FAA NOTAM (also known as FAA Notices to Airmen) Office, FAA ARTCC MIS (also known as Air Traffic Control Center Meterological Impact Statement) and other weather products, news websites and news aggregators (such as Google News or the Associated Press), NWS (also known as National Weather Service) forecasts, individual airport websites and condition reporting websites, flight tracking website streams (such as flight tracking data published by individual airlines) and/or air traffic control flight data streams, airport approach procedures minimums data (such as runways, category, ceiling, visibility, and height of airport from NOS (also known as National Oceanic Service), FAA Aeronautical Navigation Products or airport survey raw data, airport AFD (also known as Airport Facilities Directory) and geographic specific information (such as runway length, altitude, width, pavement condition, loading, available services), custom airport information input by users (including local knowledge, comments or updates), current events or security data updates, TFR (also known as Temporary Flight Restrictions), satellite radio weather information broadcasts such as Sirius or XM Radio weather information, and/or FEMA area specific alerts.

g) Any other type of data described or inherently described elsewhere in this application. It will be apparent to one of skill in the art that the preceding and following discussions inherently disclose and describe other types of data, these other data types are also to be considered TIMS data.

### Module Descriptions

In certain embodiments, a TIMS system may utilize a plurality of the following modules. As mentioned elsewhere, any TIMS module may communicate with any other module; for example, any TIMS module may communicate with the data storage module as well as the presentation and interface module. However, a TIMS user or system builder may not have need of all of the advanced capability described herein. Thus an analysis module which is not as configurable or flexible as those described herein is still an aspect of and within the scope of the invention, just as a module with additional capabilities is an aspect of and embodies this invention.

Airport and/or Airspace Modules

The airport and/or airspace modules may analyze TIMS data and/or provide data to a user or to other TIMS modules related to aircraft, airport and/or airspace TIMS Data.

Data Storage Module

The data storage module stores and/or retrieves and/or serves data to and from the other modules or non-module sources by any of the methods commonly known in the art, for example, into RAM or registers, into a database or databases, into a computer file system, into a “cloud storage” service, or into any other currently known or later developed system suitable for storing data. The data storage module may receive and store data acquired by the data acquisition module, and may transmit stored data to other modules such as the presentation module. The data storage module may build and store databases containing such data, parse incoming data, and store and maintain the retrieved data sources.

The specific data that is retrieved, stored or transmitted may optionally be relevant to any airport with an ICAO (also known as International Civil Aviation Organization) identifier and the airspace and geographic area surrounding it. TIMS Data may be stored arranged by airport code, by aircraft number, by client, split between airport operations and weather data, or in any number of other organizational schemes or arrangements. It will be apparent to one of ordinary skill in the art that TIMS data may be arranged, categorized, or stored at least according to any criteria inherent in the stored data itself.

The data that is retrieved, stored or transmitted may also be specific to the current or predicted weather as well as the operational status of an airport environment itself. For example, current weather observations and terminal area forecasts may be collected as well as taxiway and runway conditions, current and predicted air traffic delays. Area information such as current security or health threats, national holidays or area specific political unrest are also retrieved. The goal of the data retrieval and storage modules is to provide the analysis module with all available data that could affect safe and efficient flight operations at a specific airport as well as providing the data storage module with relevant historical data.

Database programs, data parsers, programs, scripts and other tools commonly used in the art for these purposes include but are not limited to Cold Fusion, MySQL, Oracle, Microsoft SQL Server, PostgreSQL, PHP, Python, Django, Ruby on Rails, Linux, the Apache Web Server, database abstraction layers, Jinja templates, libxml, BeautifulSoup and others may optionally be used to implement this portion of the invention. A robust backup and recovery system may also be an important aspect of this module.

Data Acquisition Module

The data acquisition module queries, receives, captures and/or obtains TIMS Data as described herein, from any of the sources described in the description of TIMS Data, or by and of the data acquisition methods commonly known in the art such as user input, screen scraping, database querying, SQL, remote procedure calls, signals intelligence, monitoring radio broadcasts and transmissions, via GPS, receiving digital signals such as wireless digital communication network signals, interfacing with onboard instruments, avionics, or from weather stations, via websites, electronic mail, SMS, TCP/IP packets, by receiving data transmissions from individual aircraft, polling the output of aircraft or non-aircraft sensors, and interrogating the computer systems of data providers or other entities. It will be appreciated from the preceding and following disclosures that TIMS can collect TIMS Data using computerized or non-computerized data sources and data gathering methods known in the computer arts. For example, an airline, weather station, aircraft, airport, or other data provider may provide TIMS Data via a: website, customized data feeds or APIs, email messages, an FTP site, email feed, XML weather feed, social media outlet, personal weather stations, personal weather cameras, websites (including but not limited to the NOAA, AWC (also known as Aviation Weather Center), Accuweather, ARINC (also known as Aeronautical Radio Incorporated), and NOTAMs), SMS messages, radio transmissions, or via other modes of known data transmission. TIMS may passively collect data provided or pushed to it by data providers, or it may actively collect data, for example by querying or screen-scraping such data. TIMS may collect data from subscription or non-subscription data services, from user input via end-user terminals, from search engines or news reports, from stationary navigation beacons, radio broadcasts, wireless or cellphone networks, onboard transmission and/or relay systems, or from any other source. Further TIMS may collect data from one, more than one, or all of these sources simultaneously, in series, or according to defined polling schedules. Additionally, TIMS data collection can deal with data inputs which are intermittently available, or occasionally have errors, by using caching and data smoothing techniques. TIMS may also collect data from nearby devices, such as desktop or laptop computers, or from aviation control equipment, or from computer systems installed into airplanes, or from computer systems used in air traffic control, by wired or wireless links such as Ethernet, USB, FireWire, Bluetooth, Near-Field Communication, Thunderbolt, Wi-Fi, or other means of communication. The data acquired by the data acquisition module may be communicated to other modules directly, including but not limited to the data storage module.

The data acquisition module may optionally be triggered by temporal priority based on the volatility of the source data. For example, global terminal aerodrome forecasts are issued four times in 24 hours, therefore they could be collected up to 4 times per day, i.e. after each publication. Meanwhile, station observations (METARS) are issued at one hour intervals or as conditions change, therefore they could be collected every 30 minutes or less in order to catch potential changing conditions in timely manner). Current news events may be collected in as little as once an hour. Notifications from Twitter or similar microblog sources could be captured every few minutes. Data could also be received via “push” technology, whereby when the data source has new data to send it transfers said data, rather than waiting for a request from TIMS. The data retrieval module may optionally be dependent on, or independent of client requests to monitor an airport, so as to ensure a historic database is built and maintained regardless of specific requests.

Data Conversion Module

The data conversion module may convert any or all items obtained from the data acquisition, input, or other modules which acquire, collect, receive, or gather data into more preferable formats for storage or use by other TIMS modules. By way of non-limiting example, the data conversion module may receive raw data obtained from any other module or from non-TIMS sources, recognize that source data type, parse and store it into the TIMS data storage module or transmit it to another TIMS module for further use. For example, if the data acquisition module is configured to receive weather data from multiple sources, the data conversion module may be configured to convert the data from each of the weather data sources into a common format, or simply into formats which may be preferable for storage by the data storage module, or into a common format which may be used by other modules.

Analysis Module

The analysis module may perform analysis on weather, operational data, and other TIMS data (particularly data related to an airport with an ICAO identifier) for the purpose of detecting potential threats, unsafe or illegal situations, conditions which the user indicates are undesirable, or any other analysis or result which the user wishes to monitor. Inside this module threats are defined as any data or combination or data that may cause delayed or unsafe or illegal flight operation. The analysis module can accomplish this by various data analysis methods known to those skilled in the art, including but not limited to comparing one data element against another, comparing stored data against a query, searching, matching, using regular expressions and sorting. As will be evident to one of ordinary skill in the art, the output of an analysis by the analysis module or any other module performing analysis may be considered new TIMS data, and may be stored by the data storage module, forwarded to any other module, presented to the user, used as the input to a further analysis module, or used to generate an alert; although the invention is not so limited.

The analysis module can be configured to perform a plurality of the following analyses, or any of the analyses discussed elsewhere in this application, as well as respond to a plurality of status indications resulting from or relating to said analyses by alerting the user or other software modules: Check for Metar Precipitation Items, including non ice items (e.g. wet and contaminated runway), Check for Metar Ice related items, Check for Metar for Rain and Temps below Freezing Temperatures, Check for Metar Ceiling, Check for Metar Visibility, Compare Metar Ceiling Trends against history from TIMS Data, Compare Metar Visibility Trends against history from TIMS Data, Compare Metar Pressure Trends against history from TIMS Data, Check Metar for Vicinity Weather (wet and Contaminated runway), Check Metar for Critical Weather (thunderstorms, tornados, hail, LLWS etc.), Check Metar for Wind Gust Alert, Check Metar for WS (Windshear Report), Check Metar and TAF for Wind Shifts, Check TAF for Forecasted Precipitation, Check TAF for Forecasted Low Visibility and compare to Instrument Approaches, Check TAF for Forecasted Ceiling Issues and compare to Instrument Approaches, Check TAF for Forecasted Wind Gusts and compare to runway orientation, Check TAF and METAR to Wind/Runway Limitations compared to runway orientation, Check for NOTAM Runway Closure, Check NOTAM for ILS (also known as Instrument Landing System) or VOR (also known as Very High Frequency Omni-Directional Range) or OTS (also known as Out of Service) indications, Check NOTAM for Approach Light OTS, Check NOTAM for Braking Action or Runway Surface Issues (an alert could generate a phone number to call for actual conditions based on airport contact information), Check FAA Airport Ground Stops, Check FAA Ground Delays, Check MIS impact statements, Check regional Sigmets (also known as Significant Meterological Information) or Airmets (also known as Airmen Meterological Information), Check regional NWS forecasts, Check Airport Security Status, Check Airport AFD Information against aircraft type, Check Territorial Security Concerns, Check Services Required Based on Weather (De-ice, Hangar), Check Overnight Temperatures for Hangar/Ramp, Check News Events that may impact travel, Check airport specific web sources or travel issues, Check and Compare all Ceilings Issued or Forecast Above Airport Database Minimums for Runway expected, Check and Compare all Winds Forecasted or Actual, and Check for Metar for Pressure Falling Rapidly Notice.

It must be appreciated by one of ordinary skill in the art that the analyses carried out by an analysis module as discussed herein could be configured to analyze TIMS data which is either broad or narrow in scope, all of the TIMS data or a subset of it, and that those analyses could be applied to a TIMS data according to the desire of the user in several ways, including by either configuring the analysis module itself and indicating the desired scope of output, or by providing the analysis module with input which is a subset of TIMS data which would lead the analysis module to generate the desired output. Analyses with broad or narrow scopes, or which report individual data elements or a plurality of data elements, or which report data elements related to the data element undergoing analysis, are all different aspects of and within the scope of this invention.

By way of non-limiting example which will explain to one of ordinary skill in the art how any of the aforementioned analyses could be so implemented and configured, the “Check Overnight Temperatures for Hangar/Ramp” analysis could report either the overnight temperature for one particular Hangar or Ramp by being so configured, or it could report that individual data point by having a TIMS data record for only one airport or hangar or ramp communicated to it, or it could report that individual data point by being referred to the TIMS storage module with instructions to retrieve data on only one particular hangar or ramp. Likewise, the same analysis module could be used to report whether an overnight temperature for a particular hangar/ramp is out of a safe or legal range for a particular airplane by comparing the result the “Check Overnight Temperatures for Hangar/Ramp” analysis with the TIMS capability data for said airplane. Alternately, the analysis module could perform the aforementioned analyses related to “Check Overnight Temperatures for Hangar/Ramp” on a set or list of hangars/ramps, and return a list of results, in several different ways including communicating the TIMS data for several hangars/ramps to the module, or by instructing the module to retrieve the data for a set of hangars/ramps from a data storage module, or by instructing the TIMS data storage module to communicate a set of hangars/modules to the analysis module. As previously discussed, each of the analyses described in this application may be configured, used, executed, or operated in the same ways as described in this illustrative example.

As an additional example, an analysis module could combine TIMS Data about an airplane's operational characteristics, such as required landing distance, with TIMS Data about current meteorological conditions at an airport, such as ground ice or precipitation, to determine that landing is unsafe.

It will be apparent to one of ordinary skill in the art that the output from any of the analyses discussed herein can serve as an input for a subsequent analysis which could at least report the various logical combinations or operations of the outputs of the two analyses, for example, the AND, NOT AND, LOGICAL IMPLICATION, LOGICAL NON-IMPLICATION, OR, EXCLUSIVE OR, NOT OR, or EXCLUSIVE NOR operations. Thus, as an illustrative and non-limiting example, the output of the analysis “Check FAA Ground Delays” and the output of the analysis “Check FAA Airport Ground Stops” could be combined to report a set of airports where:

A) There are neither ground delays nor ground stops (NOR),

B) There are both ground delays and ground stops (AND),

C) There are not both ground delays and ground stops (NOT AND),

D) There are ground delays or ground stops (OR),

E) There are either ground delays or ground stops but not both (EXCLUSIVE OR),

F) There are both ground stops and ground delays, or neither ground stops nor ground delays (EXCLUSIVE NOR),

G) A ground delay does not result in a ground stop (LOGICAL IMPLICATION), and the like for other logical operations.

These or other logical combinations of analyses, or combinations of combinations, whether illustrated by an example or not, are aspects of the invention and within its scope.

Likewise, the results of said aforementioned compound analysis could be combined with the output of additional analyses, or additional compound analyses, in a series and/or parallel arrangement, to achieve almost any desired logical query or analysis of TIMS data.

In certain embodiments, TIMS may be configured to have a two tier analysis and alert system. A first analysis module creates first level alerts or notifications, which may be communicated to a user, to the data storage module and/or are passed to a second level analysis module. The second level analysis performs extra analysis and processing, including by combining the results of the first level analysis with additional results from other TIMS analyses, including analyses of other TIMS data such as but not limited to:

A) Environmental data, including aircraft, airport, and user operations information; basic human risk assessment analyses;

B) Comparison of first level alerts with historical trends;

C) Comparison of current status indications with known interactions of similar status indications from historical TIMS Data;

D) Comparison of environmental variables with the first level alerts, followed by a re-evaluation of first level alerts in view of current air traffic control operations;

E) Broader sweeps of accident or incident TIMS Data for similar conditions;

F) Performing final customized checks after other checks or analyses have completed; and

G) Applying an alert time frame.

By way of non-limiting example, a two tier analysis and alert could be configured with TIMS Data relating to the loaded weight of an airplane, the current amount of fuel onboard, the fuel requirements, and a flight plan with multiple stops. The analysis module could activate the first tier of the alert by combining and comparing, for example, the weight, fuel requirements, and onboard fuel of the airplane and determining that the airplane needs to take on fuel at an intermediate stop. Once the first tier has been activated, the alert may be stored or communicated to the user or another module, for example user may optionally be notified by the of the first tier alert that the airplane will need to refuel to reach all stops. Subsequently, the analysis module could compare the airplane's fuel requirements to TIMS Data relating to fuel availability at an intermediate terminal and determining that the intermediate terminal does or does not have fuel to satisfy the requirements. At this stage TIMS may optionally generate a second tier alert and notify a user of the alert, or send a signal to another machine, software module, or a ground station.

In certain embodiments, so-called “artificial intelligence” systems may be used in the Analysis module to perform analyses with or without specific configuration or instructions from the user or system designer. For example, one type of artificial intelligence system known as a Neural Network is well known in the art and well adapted to take large sums of data and perform analyses based on the training of the network. An analysis module may optionally utilize a Neural Network trained using historical TIMS data and then used to detect patterns or identify current situations in other TIMS data through user or system builder configuration. As a non-limiting illustrative example, historical TIMS Data related to weather conditions, airport configurations, and landing accidents could be used to train a neural network, which would then identify dangerous conditions for a particular aircraft without a specific request or configuration by the user to identify such conditions.

Similarly, other sorts of artificial intelligence systems including Knowledge Based Systems and/or Expert Systems are commonly known in the art and could be used to implement a TIMS Analysis Module. Any of the TIMS Data sets or combinations of TIMS Data sets described elsewhere in this application could be used to train or inform a Neural Network, Knowledge Based System, or Expert System, which could then analyze or monitor any TIMS Data stream to generate alerts. The results may optionally be communicated to other modules, or an alert may be generated to the user or passed to the alerting module.

Alternately, an analysis module could be implemented with heuristic analysis, scripts, programmed responses, or user-defined queries as are known to those skilled in the art.

Client or User Profile Module

The client profile module may collect, process, present, configure and display client or user profile data. The client or user profile module may receive, store, process, present and/or edit at least a plurality of the following types of data, which are to be included in the definition of TIMS Data, though the invention is not so limited: user account information including username, password and email address; home base or home airport terminal information; associated aircraft information, including a record on the type of association with the user (optionally a normal user account could store information on a certain number of aircraft, and a premium user account could store information on additional aircraft); user preferences; customized or programmed user alerts, analyses, or reports; records of user related items with expiration dates and associated warning notice lead times, such as FAA medical expiration with a one month or one week time frame to notify in advance, passport(s) or travel visas with a six month, one month, or one week time frame to notify in advance. It must be appreciated that the aforementioned data items and expiration dates are purely examples and do not limit the invention, other data items could be similarly stored.

Client Request Module

The client request module may receive client or user requests to monitor a specific airport in support of a flight operation. This module may also receive client requests to configure or program particular alerts by comparing, contrasting, cross referencing, or otherwise analyzing any TIMS data elements with any other TIMS data elements. The module may receive a user's account authentication, and optionally: a list of the airports to be monitored, the time of monitoring for each, and the specific conditions to monitor for.

Direct Website Access Module

The direct website access module allows a user to send a request to TIMS via an HTML or AJAX form on a website such as http://www.guardmyflight.com.

Input Module

The input module may receive and/or process client or user input data and monitor or query data channels for input or other requests; including but not limited to automatic data feeds, website form submissions, manual or automated user data entry via a computer, tablet, or smartphone app, SMS or MMS text messages, or from third party software. Input may include user identification, airport identification, and arrival and departure schedules.

Analysis Module

The analysis module may monitor and query the TIMS Data in the data storage module, and make decisions regarding potential risks to flight operations;

Alert and/or Alternative Action Module

The alert and alternative action modules may alert the user or client with specific and intelligent warnings and optionally present alternative courses of action. The alerting and alternative action module may operate in communication with or work in conjunction with the analysis module, the data storage module, the. The alerting module may receive alerts regarding threats or other monitored conditions and communicate them in a prioritized and summarized format along with alternative courses of action to promote and safe flight operations.

The alerting and/or alternative action module may be configured by interaction with the user to create additional alerts or alert conditions on the fly, or by the system builder without the intervention of the user. In certain embodiments, alert time frames are configurable steps whereby an alert becomes more critical For example, a level 5 or “preplanning alert” may occur at any time, a level 4 alert may occur 24 hours prior to the scheduled flight, a level 3 warning may only occur up to 12 hours before the scheduled flight, a level 2 warning may occur 6 to 3 hours before the scheduled flight, and a level 1 warning may occur any at any time during or up to three hours prior to a flight. A user of the system may configure the different actions taken to alert the user at each level of alert, including alerting the user via email, sounds, telephone calls, vibration, in-cockpit alarms, and/or contacting other responsible parties or systems such as air traffic control or other aircraft.

As alerts are passed from the analysis module, they may be temporally prioritized for relevant client alerts. This involves analysis by the analysis module of potential threat conditions with respect to whether a current threat will impact operations occurring in the future. By way of non-limiting example, if an airport is being monitored for a night flight operation occurring several days in the future, and the airport experienced evening fog tonight, the alert module will de-prioritize this alert because of the time frames involved; for example it need not be communicated to the user, or it could be communicated to the user as an informational notice rather than a warning. However if for the past three nights fog was present overnight an alert will be generated that even if not forecasted, overnight fog is a threat because of its repeated occurrence in temporal proximity to the flight operation. Prioritization occurs via simple logic based analysis modules using event time triggers which may be pre-programmed or configured by the user.

Non-limiting examples of time triggers include: an alert requiring immediate transmission regardless of time, such as that the airport will be closed at the time of operation, or weather forecast or tend information issued at 3, 6, 12 and 24 hours prior to flight operations. Alerts may be logged in the client profile database and/or in the data storage module and either communicated to the presentation module, or enqueued and later passed to the presentation module.

Additionally, the client can choose to be alerted in the case that any status indication derived from TIMS data changes. For example, a change in one of the following TIMS data status indications may be incompatible with either preset or customized safe and legal flight parameters, and generate an automatic alert to the user/client or another module: LIFR (also known as Low Instrument Flight Rules)/IFR (also known as Instrument Flight Rules)/VFR (also known as Visual Flight Rules), Runway Minimums, Wet Runway, Contaminated Runway, Crosswind on Runway, Heat or Density Altitude Warning, Critical Weather Alert. Optionally, one or more of these status alert conditions is always set to alert the user and cannot be turned off.

The AI module can be executed in three modes: continuous airport monitor, selective airport monitor or mixed mode. In continuous airport monitor, each airport in the ICAO database is analyzed on a set time cycle. In selective, the airport is analyzed only when a client request is received. In mixed mode a selected set of frequently requested airports are analyzed on a time cycle and when requested, other airports are analyzed on demand.

Alternative Action Generator

The alternative action generator may be part of the alert module, or it may be a separate module. It receives alerts from the alert module and attempts to generate alternate courses of action, within the capabilities, operational limits, user preferences, goals and other data which it receives from the data storage unit. These alternative actions may be communicated to the user, to another module, or stored in the data storage module. A user could optionally request an alternative action when presented with any report or analysis if the outcome of the analysis is not to his preference.

By way of non-limiting example, the alternative action generator may receive or retrieve an alert that an airport associated with a flight plan has delays. The alternative action generator could then select an alternative airport based on geographic location, air traffic, delay status at other airports, a pre-programmed alternate airport or diversion airport, or other pre-programmed or user configured criteria. With respect to geography, airports may be identified based on a latitude/longitude calculation from the airport directory database and cross checked against basic runway and navigation requirements. Additionally, the selection of potential airports could be limited by TIMS data such as the fuel load.

Should the user accept or initiate an alternative action, the entities associated with the alternative action may become monitored in the same way as those entities which were previously the active action or plan were monitored. If a suitable alternate is not found by the alternative action generator, a time change of operations will be suggested based on the TIMS report.

In certain embodiments, the TIMS Custom Alert Module is operable to periodically check the database for user defined, or user profile related alerts, such as to perform the following analyses: Check medical, passport and other licenses for pilots and other aviation professionals and report future licensing requirements to the proper stakeholders.

Although the illustrative example describes an alternative action involving an airport selection, the invention is not so limited. The alternative action generator may also generate alternative actions for any entity on which there is TIMS data, for example a different hangar facility based on availability, a different fixed base operator based on fuel costs, or a different flight plan or air corridor based on weather or air traffic.

An alternative action may optionally be generated for all actions, regardless of the presence of an alert. Additionally, when an alternative action has been generated, its existence may be noted on any reports provided to the user.

Presentation and/or Interface Module

The presentation and interface module (or modules) are those modules with which an end user or users of the system will view or interact with. One important aspect of the presentation module is the summary generator. The summary generator receives relevant alerts, optionally prioritized by the alert or an analysis module, and generates a plain human readable, preferably readable by a layman, assessment of the risks to safe and efficient flight operations by airport, by region, by aircraft, by flight plan, or by any other desired criteria. Reports may be generated by an input templating system such as Django, Jinja, Ruby on Rails, Crystal Reports, or some other similar system which would allow summaries and reports to be customized for end users or clients. The client or user may be notified via TIMS data, for example user profile data, which indicates the clients preferred methods of communications. Non-Limiting Examples of Transmission are Email, SMS, Voice Call, and smartphone or tablet app notifications. If the report includes the recommendation to delay or cancel flight, a request for analysis may be passed to the alternative action generator along with the report. The report may be logged in the client profile module as well as the data storage module.

Other Modules

It will be appreciated by one of skill in the art that other modules may be included in the invention, such as may be disclosed explicitly or inherently elsewhere in this application.

### Exemplary Features Obtained by Configuration of TIMS Modules

To practice the invention, a person of ordinary skill in the art need only implement a plurality of the TIMS modules and configure them so that they are in communication with one another to produce the desired result. In such a way, a TIMS system, apparatus, or method of use may be practiced. It will be appreciated that the following are illustrative examples of embodiments and aspects of the invention, rather than limitations on the invention. Through the flexibility and innovation of TIMS, the following functionalities are disclosed and enabled.

Alternative Mobile Monitoring Request

A user or client may submit a request or other input to TIMS through a series of TIMS or non-TIMS services that pass the request back to an input module. Non-limiting examples of these include mobile phone or smartphone requests, SMS, mobile, website, mobile website, and voice recognition service, and dial-tone entry.

Third Party Software Interface

A user or client's request to monitor or other input may also be passed by third party software or websites to an input module. Non limiting examples of these include Flightpak, FOS, Flight Explorer, Arinc Direct.

Email Forwarding

A user or client may forward a simple text or HTML email, or message in any other format, containing travel details along with authenticating information to an email address in communication with a TIMS input module. The module will read, parse, extract the relevant details and configure TIMS to respond to the client's request, for example to monitor an airport, airplane or flight plan.

Current Weather Observations

TIMS Data may be gathered from various sources as described elsewhere in this application, including but not limited to instruments onboard an aircraft. These current observations may be used to update, confirm or revise the results of prior analysis, or may optionally be passed to other software modules including the alerting module or the presentation module. In this way the TIMS system could be used as a general purpose weather reporting tool by non-aviation related users.

Historical Surface Weather Observation Trends

TIMS data relating to historical surface weather observations may be used to detect trends or combinations of data sets, for example by using a neural network trained using the historical data to analyze and detect present threats. For example, TIMS data from the data storage module could be used to train a neural-network based analysis module to monitor conditions likely to cause severe weather such as tornadoes or lightning storms. TIMS could then alert stakeholders by the use of other modules in areas likely to be affected by such severe weather.

Forecasted Weather

A analysis module incorporating a Knowledge Based System may be used to detect current threats due to forecasted weather. For example, TIMS data on a particular airport may indicate that it shuts down runways when there is a certain amount of precipitation. That data could be combined with other TIMS data on weather forecasts by an analysis module to predict a threat due to the weather forecast. The results may be passed to the alerting module

Regional Status

An analysis module incorporating a Neural Network, Knowledge Based System, Expert System, or other computational technique may be used to analyze regional meteorological and ground conditions and to generate an alert when potential threats become more likely over a region. For example, given historical TIMS Data on weather and delays, as well as current TIMS Data on weather conditions in a region and a flight plan that originates or terminates at an airport in aforementioned region, a TIMS Analysis module could predict delays at airports within or near the region.

Current Air Traffic Current or Predicted

An analysis module incorporating a Neural Network, Knowledge Based System, Expert System, or other analysis technique may be used to analyze current Air Traffic conditions and to generate an alert when potential threats become more likely. For example, given historical TIMS data on air traffic, as well as current TIMS Data on flight plans, a TIMS Analysis module could predict fuel shortages or delays at particular airports.

### Exemplary Embodiments of the Invention

In one embodiment, a TIMS system may have a plurality of servers executing a plurality of TIMS modules and a plurality of clients executing a plurality of TIMS modules; where each of the clients is in communication with one or more of the plurality of servers or other clients.

In certain embodiments, a TIMS system may acquire TIMS data using a data acquisition module, a client request module, an input module, and/or one or more other TIMS modules. The TIMS data may then be processed by a data conversion module either before or after being stored by a data storage module. Optionally the TIMS data may not be stored, but could be communicated directly to other modules in the TIMS system, or could be communicated directly to other modules simultaneously with storage. For example, the data may be communicated directly to one or more of an airport and/or airspace module, an analysis module, a presentation and interface module, a client or user profile module, a direct website access module, an alert and alternative action module, a presentation and interface module, or any other TIMS module. A user might access the TIMS system using a presentation and interface module, an input module or a direct website access module.

In certain embodiments, the a TIMS system will utilize its constituent modules to obtain and maintain situational awareness of the airports, terminals, aircraft or other entities it is tasked with monitoring. TIMS does this by analyzing and comparing the previously collected TIMS data to user specified queries or, in certain embodiments, flight plans. In certain embodiments, the client's user profile, their use history, the capabilities and characteristics of the aircraft to be flown, the navigation and physical specifics of the airports, the current and predicted weather, the current and predicted air traffic, and current and predicted airport and surrounding environments operational status may be analyzed, compared and combined in various ways to provide situational awareness. TIMS can be configured to provide alerts, recommendations, alternative courses of action, and warnings of inappropriate or dangerous flight plans or conditions based on a series of previously known or calculated threat combinations that would delay or cancel, or cause unsafe or illegal, flight operations. Furthermore, in some embodiments, TIMS may employ techniques of machine learning and neural networks to learn or calculate previously unknown threats from stored TIMS Data, including by comparing past weather and operational events, such as accidents, or mechanical or crew failures, to predict future threats. In some embodiments, TIMS may be configured to generate summaries of portions of TIMS Data for consumption by end-users such as pilots or air-traffic control personnel, which are specifically relevant to the operational needs of those end users. For example, TIMS may generate a report for a pilot or other end user displaying only the non-redundant meteorological data most relevant to an actual or planned flight plan or other flight operations along with alternate courses of action. Further, TIMS can be configured in certain embodiments to summarize the available and relevant TIMS Data into a “Go”/“No Go”, or “Yes”/“No”, or “Safe”/“Unsafe” output format for a particular proposed or actual flight plan. TIMS could further explain how that output was calculated on the request of a user. A yes/no report in this fashion is highly useful to a user such as a pilot or other aviation professional, who frequently must make a very quick decision in response to a client's query about a potential flight. Additionally, or in the alternative, TIMS could summarize the probabilities associated with TIMS recommendations and provide information in an output format which includes a degree of risk associated with a particular course of action, such as a Red/Yellow/Green display, with the aforementioned colors corresponding to specific levels of risk. It will be appreciated that the aforementioned descriptions do not limit the TIMS system but rather are exemplary of its capabilities. TIMS can be configured to collect, process, analyze, and output the TIMS data in various other ways.

In other embodiments, a TIMS system can actively and continuously monitor conditions according to for specific user preferences or requests and then issue alerts when a condition exists, is predicted to exist, ceases to exist, or is predicted to cease to exist that would or is causing unsafe, illegal or inefficient flight operations. Furthermore, TIMS can recommend alternate courses of action during the preflight planning phase, during a flight, or at any time when conditions have changed in a way which changes the outcome of any TIMS analysis, for example if a weather forecast changes during a flight, or if the safety, legality or advisability of a flight plan changes during flight.

Another aspect of the invention are the various services which can employ the TIMS system to deliver TIMS Data to end-users. In one embodiment, a web based service optionally known as “Guard my Flight” is in communication with and employs at least a subset of the functionality provided by TIMS. TIMS provides and monitors the weather, ground conditions, aircraft conditions, airspace conditions, terminal conditions, and other desired TIMS Data to Guard my Flight. In one embodiment, Guard my Flight will then advise stake holders, for example pilots, crew, passengers or aircraft owners, of current or predicted conditions that would delay, cancel or cause unsafe or illegal flight operations as well as provide alternate courses of action to avoid an unsafe flight operation. In various embodiments, Guard my Flight could be a website, computer application, smartphone app, tablet computer app, or a combination of the above. Likewise, in various embodiments, Guard my Flight could communicate its alerts to stakeholders via email, text message, web pages, automated telephone calls, prompted human telephone calls, FAX transmissions, or other methods. Expanding on the idea of preventing and unsafe flight operations through intelligent and predictive correlations of available airport weather and operational data, Guard my Flight practices the invention of the TIMS system by providing the general public and non-flying aviation stakeholders with continuous monitoring of flight operations and to advise when an unsafe of delayed flight operations is possible. End-users could pay for Guard my Flight by subscription, on a per-flight basis, as part of an insurance package (such as travel insurance), or it could be bundled with other products or services, for example an airline ticket, vacation package, or fractional jet ownership or use contract.

Another embodiment is the Guard my Flight system described in this application. In one configuration the Guard my Flight system contains at least TIMS modules including a client request module, data storage module with a database back-end, data acquisition module, data conversion module, several analysis modules, an alerting and alternate action module, a request processing module and a presentation and interface module. Additional modules that make up the balance of the Guard My Flight service may include: an ad placement/generation module, value added modules and databases to perform support tasks including a pilot connect (social media) connection and data base, a pre and post operation feedback module, a trip distress and interruption module, an SMS module, Flight Plan filing module, Ground Logistics Support module and database, Flight operations information support module and a historical airport data access module.

The Guard my Flight system could further be implemented as a method of doing business for airlines, air charter services, private pilots, or other aviation related businesses as an extra value added service for their clients. A client could use the guard my flight service to check on the status of a planned or contemplated flight, and receive instant feedback on safety or delay considerations. Alternately, a reservation manager could utilize the Guard my Flight system while taking reservations over the phone, over email, via text message, or through other communications with clients. This would enable the reservation manager to provide more valuable insight into potential trips than without the analytical abilities of the TIMS system.

### Methods of Doing Business and Revenue Sources

The innovative architecture of TIMS and/or the Guard My Flight system allow several add on services. These services may either be a benefit to attract continued use or a value added paid subscription service. The following a simple description enabling one of ordinary skill in the art to practice these aspects of the invention. Note that each of these add-on services may be implemented as TIMS modules and as such, may utilize the services provided by any of the TIMS modules described in this application, any of the TIMS data described in this application, and their output, processing, or features may in turn be used by any other TIMS module. Likewise, all of their data is TIMS data which may be communicated to other modules, or to a user, including the data storage module.

Pilot to Pilot Connect

TIMS may employ delayed or real time communication links and infrastructure allows for end users to update all other users and TIMS itself on the actual conditions encountered in real time. This capability is highly valuable to aviation professionals. The pilot connect concept expands on the half century old FAA system of “PIREPS” (Pilot Reports) by allows pilot to give short plain English reports of current weather and airspace conditions to all other users. Pilots can be awarded bonus value added services and discounts by taking the time and participating in this system. Alerts on specific areas would include “pilot connect” updates. Similar to Twitter and other social media, this system will keep users connected in real time.

FBO and Airport Guide and Destination (Layover) Information

TIMS may transmit back location information to the end user once a request to monitor an airport has been received. This also allows for advertisement and non-critical but useful information to be passed during the trip planning phase. Items that could be transmitted include links for onsite FBO (fixed base operations or fixed base operator) services, airline and car rental information, local attractions, current news, upcoming events (strikes, holidays), security briefings, navigation information, associated websites, reviews of local venues, pilot connect comments on the surrounding areas, and the like.

Corporate Aviation Trip Distress

Unlike large airlines, corporate aviation or other smaller aviation operations typically have very few aircraft and few options when they break. The crew is normally left scrambling to repair their aircraft while making alternative travel plans for their passengers at the same time. TIMS/Guard My Flight may provide available charter options (including by contacting brokers and acquiring broker information), airline flight schedules, local ground transportation options, repair facility information and local hotels reservations and/or alert corporate colleagues. This service may be triggered automatically by alerts or by user intervention.

Business Traveler Trip Distress

If the system is being used by a frequent business traveler, an airline flight disruption has the obvious effect of needing to check alternative airline flights and their current status. TIMS may provide hotel, car rental, and other travel assistance with opportunity to show airport terminal and area specific advertisements. The assistance may be triggered automatically by alerts or by user intervention.

Flight Crew Trip Planning

When a user configures an airport monitoring request, TIMS may take the user profile, destination and assist with all trip planning aspects such as FBO notification, ground logistics, etc.

SMS Compliance Service

The implementation of a Safety Management System (SMS) is a requirement for current corporate flight operations to fly outside the US. It is expected to become a domestic requirement in coming years. SMS is a system of risk mitigation that centers around analyzing threats to a specific flights through a point based checklist system that is completed prior to flight. For example, a flight at night might be worth 2 points while a flight near thunderstorms at night is worth 10 points. The more points, the more risk. SMS requires storing, documenting and addressing these risks prior to flight as well as having a robust system for reporting risks post-flight. TIMS/Guard my Flight may be configured to automatically complete a risk analysis customized to a flight department's SMS program. Unlike current SMS risk mitigation plans, TIMS can actively monitor and address threats well before, during and after a typical preflight risk analysis occurs. This is another value added service that can be customized to an operations SMS program. Similarly, other pilot or mechanics checklists commonly known in the aviation community can be integrated into TIMS. TIMS could also use the alternative action generator to propose less risky flight options. TIMS could also link SMS Compliance to the GO/NO GO, or “level of risk” report generated by other modules and provide a variety of flight options along with corresponding levels of risk. In certain embodiments, the TIMS Report Generator will generate a plain English, time sensitive risk assessment of the operation, and also generate alternative courses of action based on the results of the analyses undertaken by the Analysis Module(s).

Filing Flight Plans

A basic function that goes with any trip planning as a pilot is filing a flight plan. TIMS may be configured to file flight plans for the actual operation to be conducted. Partnering with third party flight planning services may also be provided.

User Requested and Non-User Requested TIMS Data Alerts

A value added service to clients, non user defined database alerts may be integrated into TIMS alerting module. For example, if a user/client requests only an analysis or monitoring of an airport, other alerts may optionally be triggered, such as that their passport soon will expire. These alerts may also be user definable.

Other Database Usage

During the course of the Guard My Airport system, TIMS may build an extensive historical database of past airport weather conditions, pilot comments, airport and air traffic conditions, and other TIMS data. This database may be utilized by the Neural Network of TIMS to predict future correlations that may affect operation. In short, TIMS will know what conditions in the past caused an unsafe or delayed flight operation and will apply that data toward future predictions. However, this database is also useful for aviation stakeholders on it's own due to the extensive and unique data collected. This data may be provided to third parties to generate additional revenue.

Targeted Ad Placement

Location specific advertisements can be added to any generated alerts passed to the user. If alerts are not warranted, an advertisement can be placed in the alert notification area of a report or screen.

Premium Service

As stated above, a number of value added services may be incorporated into Guard My Flight. Some of these services along with enhanced alerts can be provided on a subscription service, and other services may be provided as a free service. It will be apparent to one of ordinary skill in the art that any service, module, or TIMS data could be incorporated into either a free or paid service.

Data Mining

During the normal course of it's operation, Guard my Flight will amass a large user database of client specific travel and airport information. This rare data source can be sold to third parties

Web Page Ads

The central website for Guard My Flight will become a hub for the corporate aviation community and flying public. Ad space may be sold on the website, on other display screens, or anyplace else where users may view it.

Destination Specific Suggestions for Premium

Premium positions and generated suggestion slots will be offered on a pay system. For example, if a business traveler or a corporate crew requests trip disruption assistance or the system has the opportunity to provide ground support in general, TIMS can suggest a hotel chain that has paid a fee to have their ad displayed before other advertising customers.

Client App

Client requests, reports, or any other TIMS display or function may be performed via a smartphone application such as an Android or iPhone app, or a similar app on a personal computer or tablet computer.

### Target Customers

The following is a list and description of the target customers who will be interested in using, purchasing, or subscribing to the TIMS/Guard My Flight system. A person of ordinary skill in the art understand that these target customers, in combination with the systems, methods and apparatus described elsewhere in this application, provide several TIMS related methods of doing business.

The Corporate Pilot

Corporate Pilots are normally left to plan and execute a flight. They do not enjoy the structured environment and support of an airline pilot. Therefore, corporate pilots are routinely placed in scenarios where they are not sufficiently aware of potential threats to safe flight operations. This threat awareness is known as “situational awareness”. In their position, corporate pilots require a much high level and depth of situation awareness then their airline counterparts. The reasons for this extra “awareness” include operations into a wide variety of challenging airports and global environments, short notice trips, and multiple trips in quick succession.

The Flight Dispatcher

A dispatcher must constantly monitor flights in progress while planning future flights. In theory, a dispatcher is suppose to perform many of the tasks TIMS performs in real time, constantly updating the operation to changing airports conditions. TIMS compliments a dispatcher's duties by constantly performing the repetitive task of airport and airspace condition monitoring, thereby freeing the dispatcher to focus on all of the other tasks in real time. TIMS/Guard My Flight (or a related “Guard My Airport” service) is a force multiplier and a virtual dispatcher.

Aviation Organization Managers and Corporate Aviation Passengers

Both Corporate Aviation Management and Passengers have an interest in knowing potential flight disruptions as soon as possible, potentially even before the crews operating those flights do. Potential trip disrupting scenarios can be addressed well in advance of flight operations with TIMS alerts. These alerts could be communicated directly to passengers and managers, or the alerts could be mediated by pilots or other aviation professionals.

Aircraft Charter Brokers

A charter broker typically charters aircraft for their client base from a wide range of operators. Guard My Flight can verify that both the safety of flight and the reliability of the flights completion as scheduled are maintained.

Frequent Airline Business Travelers

As a broader application of Guard My Flight, the frequent airline business traveler can benefits from TIMS alerts by advising them of safety or airline flight disruption issues well in advance of actual operations, whether for corporate, charter, or commercial airline travel. For this type of customer, a TIMS based service is like having a professional pilot advising you on what is going on with your flight(s) and offering their opinion on what delays, disruptions and risks may occur. Such travelers may use TIMS services purchased on their own, provided independently from a third party, or provided by an airline or other carrier. Any of these providers of TIMS services may charge a fee, or incorporate the service into the price of a ticket or other service.

Aviation Logistics Support Employees (Ground Crew and Ground Transportation)

As secondary stakeholders in flight operations, airport ground personnel and ground logistics can plan ahead for possible flight delays with a specific flight operation or airport. Be receiving constant and predictive intelligent alerts, support personnel can adjust their manpower and schedule accordingly without waiting for a flight delay to occur.

Life Flight (Aeromedical) and Law Enforcement Aviation Personnel

Predicting the safety of future flight operations can literally be a matter of life and death for those in law enforcement and aeromedical aviation. Guard My Flight can predict operation limiting weather before any crew may be aware of it, saving lives.

Flight Crew Library and Tools Enhancements

By Guard My Flight's website or app a must stop location for flight operations, adding items such as free flight planning tools and free content libraries can enhance the experience for flight crews. As a one-stop shopping location for preflight and postflight planning, TIMS based services such as Guard my Flight may be sold directly to flight crews, or offered to carriers or other organizations to provide to their employees.

Third Party Software Integration

In addition to the normal means of flight guard requests, TIMS will be able to integrate with flight department scheduling and flight planning software platforms to automatically populate and initiate a flight guard on a specific flight. Guard My Flight can also receive and read flight detail emails from airline booking websites and corporate travel itineraries.

What is claimed is:

1. An electronic apparatus for providing information to aviation stakeholders, the apparatus comprising:
a CPU coupled to a memory for executing software programs;
a network interface coupled to the CPU for data communications;
a display device, coupled to the CPU, for providing information to a user of the device; and
machine readable storage, coupled to the CPU, containing software modules programmed for:
receiving current weather data relevant to aircraft operations;
monitoring and analyzing the received weather data; and
generating an alert based on the monitoring and analyzing of weather data to warn a user of the apparatus that flight operations may be unsafe and/or illegal due to weather.

2. The apparatus of claim 1, wherein the software modules are further programmed for:
receiving non-weather data relevant to aircraft operations for an airport;
monitoring and analyzing said non-weather data; and
generating an alert based on the monitoring and analyzing of non-weather data to warn a user of the display device that flight operations may be unsafe and/or illegal due to non-weather conditions.

3. The apparatus of claim 1, wherein the software modules are further programmed for:
receiving forecasted weather data relevant to aircraft operations for an airport;
monitoring and analyzing said received forecasted weather data to generate predictions of potentially unsafe or illegal conditions in the future; and
generating an alert based on the predictions to warn a user of the apparatus that flight operations may be unsafe and/or illegal due to weather.

4. The apparatus of claim 1, wherein the software modules are further programmed for:
storing aircraft data comprising operational characteristics of an aircraft;
monitoring and analyzing the received weather data in conjunction with the aircraft data; and
generating alerts based on the monitoring and analyzing to warn a user of the apparatus that flight operations may be unsafe and/or illegal for the aircraft because of the aircraft's operational characteristics.

5. The apparatus of claim 1, wherein the software modules are further programmed for:
receiving instrument data from an aircraft;
monitoring and analyzing the instrument data during flight operations; and
generating alerts based on the monitoring and analyzing of aircraft instrument data to warn a user of the apparatus that flight operations may be unsafe and/or illegal.

6. The apparatus of claim 1, wherein the software modules are further programmed for:
storing a flight plan;
monitoring and analyzing received data for each airport in the flight plan;
generating an alert based on said monitoring and analyzing to warn a user of the apparatus that flight operations may be unsafe and/or illegal near one or more of the airports in the flight plan.

7. The apparatus of claim 1, wherein the software modules are further programmed for:
generating a suggested alternative action, based on the generated alert, which avoids the dangerous or illegal situation which generated the alert; and
notifying a user of the apparatus of the alternative action.

8. The apparatus of claim 1, wherein the software modules are further programmed for:
allowing a user to input a flight plan;
analyzing the flight plan in conjunction with received weather data, and
generating an approval of the flight plan if no unsafe or illegal flight operation conditions are detected; and
generating a rejection of the flight plan if unsafe and/or illegal flight operation conditions are detected.

9. The apparatus of claim 1, wherein the software modules are further programmed for using a neural network, trained with historical weather data, in the analysis of current weather data to generate predictions of unsafe, illegal, or delayed operating conditions.

10. The apparatus of claim 1, wherein the software modules are further programmed for using a neural network, trained with historical weather data, in the analysis of current weather data to generate predictions of unsafe, illegal, or delayed operating conditions in the future.

11. An electronic system for providing information to aviation stakeholders, the system comprising:
a server computing device; and
a client terminal device, in communication with the server over a network, containing machine readable storage, for use by an aviation stakeholder;
wherein the server includes machine readable storage containing software modules programmed for receiving and storing a plurality of aviation data and text products, directly or indirectly, from the NOAA and/or the FAA; and
wherein either the server, the client, or both further contains software modules programmed for:
analyzing a plurality of the aviation data and text products stored; and
generating alerts to inform a user of the client terminal device of operational and condition changes.

12. The system of claim 11, wherein the client further contains software programmed for allowing a user of the client device to enter and store a flight plan.

13. The system of claim 11, wherein either the client, the server, or both further contain software modules programmed for informing a user of at least one of:
weather reports and forecasts;
fuel requirements for an aircraft;
alternatives available if a planned flight cannot be completed;
air traffic delays;
runway lengths at airports; and
the takeoff and landing distance data for the aircraft.

14. The system of claim 11, wherein the software modules are further programmed to inform the pilot when the conditions of fog, visibility and cloud ceiling are below safe or legal operating limits.

15. The system of claim 11, wherein the software modules are further programmed for:
allowing the user to input an origin, a destination, and a preferred takeoff time for a potential flight;
analyzing the origin, destination and preferred takeoff time together with the aviation data and text products; and
informing the pilot of unsafe or illegal conditions that could result during the potential flight.

16. A method for providing information to a user, the method comprising:
receiving destination information from the user;
receiving origin information from the user;
analyzing weather data corresponding to a plurality of flight plans between the origin and destination to detect unsafe or illegal flight conditions; and
alerting the user if unsafe or illegal flight conditions are detected for one or more of the plurality of flight plans.

17. The method of claim 16, wherein:
the information received from the user is received from a smart-phone, tablet computer, laptop, or electronic flight bag; and
the information received from the user is received by a server computing device which acquires, processes and stores weather data.

18. The method of claim 16, wherein the method further comprises:
receiving flight timing data, including date and time information;
receiving flight crew schedule information or retrieving such information from storage;
analyzing the received data to determine whether the duty schedule of the flight crew may cause unsafe or illegal conditions for any of the plurality of flight plans; and
alerting the user if unsafe or illegal flight conditions are detected.

19. The method of claim 16, wherein the method further comprises:
receiving, or retrieving from storage, threat information relating to enemy activity, hostilities, air defenses, or political instability;
analyzing the threat information in conjunction with the plurality of flight plans to detect unsafe or illegal flight activity, and
alerting the user if unsafe or illegal flight conditions are detected.

20. The method of claim 16, wherein the method further comprises generating an alternative flight plan which avoids the unsafe or illegal flight conditions detected.
